(19) United States
(12) Patent Application Publication
(10) Pub. No.: US 2025/0007138 A1
(43) Pub. Date: Jan. 2, 2025

(54) CAVITY FILTER

(71) Applicant: Nokia Solutions and Networks Oy, Espoo (FI)

(72) Inventors: Shouli JIA, Hangzhou (CN); Lipeng NIE, Hangzhou (CN); Chao LI, Hangzhou (CN); Hongjun ZHAO, Hangzhou (CN); Panpan YANG, Hangzhou (CN); Hao WANG, Hangzhou (CN)

(21) Appl. No.: 18/681,645

(22) PCT Filed: Aug. 6, 2021
(86) PCT No.: PCT/CN2021/111292

§ 371 Date: Feb. 6, 2024

(51) Int. Cl. H01P 1/205

(52) U.S. Cl. CPC H01P 1/2053

(57) ABSTRACT

Embodiments of the present disclosure relate to a cavity filer. According to embodiments of the present disclosure, there is providing an improved cavity filter. The cavity filter comprises a housing which defines a cavity and a resonator arrangement which comprises a plurality of resonant components. The plurality of resonant components are arranged in a common plane inside the cavity. The plurality of resonant components comprises a first resonant component, a second resonant component and a third resonant component. The first, second and third resonant components are arranged in an interdigital structure and spaced apart from each other. At least two of the first, second and third resonant components are arranged to be connected through a connection strip. In this way, it reduces the size and weight of the filter. It also achieves cost reduction. Moreover, it is also more flexible do design.

### FIELD

Embodiments of the present disclosure generally relate to the field of telecommunication and in particular, to a cavity filter, an antenna device and a communication apparatus.

### BACKGROUND

A cavity filter is a resonant circuit that only allows certain frequencies of electromagnetic waves to pass. A cavity filter comprises one or more resonators inside a conductive housing with input and output ports to the housing. Cavity filters may comprise tuning elements that allow the filter to have a high quality factor at a desired resonant frequency. In massive multi input multi output (MIMO) 5G base station, there may be a large number of filters for a transmitter and/or receiver, which may be quite big and heavy.

### SUMMARY

In general, example embodiments of the present disclosure provide a cavity filer.

In a first aspect, there is provided a cavity filter. The cavity filter comprises a housing defining a cavity and a resonator arrangement. The resonator arrangement comprises a plurality of resonant components that are arranged in a common plane inside the cavity. The plurality of resonant components at least comprises: a first resonant component, a second resonant component, and a third resonant component. The first, second and third resonant components are arranged in an interdigital structure and to be spaced apart from each other. At least two of the first, second and third resonators arranged to be connected through a connection strip.

In a second aspect, there is provided an apparatus. The apparatus comprises one or more cavity filters as described in the first aspect. The apparatus also comprises an antenna arrangement which comprises multiple radiator elements arranged in a two-dimensional array comprising multiple, parallel, one-dimensional sub arrays. Each one-dimensional sub-array is associated with a cavity of a cavity filter.

In a third aspect, there is provided an apparatus. The apparatus comprises: a housing defining a cavity, a resonator arrangement and an antenna arrangement. The resonator arrangement comprises a plurality of resonant components that are arranged in a common plane inside the cavity. The plurality of resonant components at least comprises: a first resonant component, a second resonant component, and a third resonant component. The first, second and third resonant components are arranged in an interdigital structure and to be spaced apart from each other. At least two of the first, second and third resonators arranged to be connected through a connection strip. The antenna arrangement which comprises multiple radiator elements arranged in a two-dimensional array comprising multiple, parallel, one-dimensional sub arrays. Each one-dimensional sub-array is associated with a cavity of a cavity filter.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which example embodiments of the present disclosure may be implemented;

FIG. 2 illustrates a block diagram of a structure of a filter according to some example embodiments of the present disclosure;

FIG. 3 illustrates a block diagram of a resonant arrangement of the filter according to some example embodiments of the present disclosure;

FIG. 4 illustrates a schematic diagram of a resonant component according to some example embodiments of the present disclosure;

FIG. 5 illustrates a block diagram of an example resonant arrangement of the filter according to some example embodiments of the present disclosure;

FIG. 6 show a topology of the resonant arrangement in FIG. 5 according to some example embodiments of the present disclosure;

FIG. 7 show a filter response of the resonant arrangement in FIG. 5 according to some example embodiments of the present disclosure;

FIGS. 8A and 8B illustrate block diagrams of resonant arrangements of the filter according to some other embodiments of the present disclosure, respectively;

FIGS. 9A and 9B show topologies of the resonant arrangements in FIGS. 8A and 8B according to some other embodiments of the present disclosure, respectively;

FIG. 10 shows a filter response of the resonant arrangement in FIGS. 8A and 8B according to some example embodiments of the present disclosure;

FIG. 11 illustrates a block diagram of a resonant arrangement of the filter according to some example embodiments of the present disclosure;

FIG. 12 show a topology of the resonant arrangement in FIG. 11 according to some example embodiments of the present disclosure;

FIG. 13 show a filter response of the resonant arrangement in FIG. 11 according to some example embodiments of the present disclosure;

FIG. 14 illustrates a block diagram of a resonant arrangement of the filter according to some example embodiments of the present disclosure;

FIG. 15 show a topology of the resonant arrangement in FIG. 14 according to some example embodiments of the present disclosure;

FIG. 16 show a filter response of the resonant arrangement in FIG. 14 according to some example embodiments of the present disclosure;

FIG. 17 illustrates a stereoscopic view of a cavity filter according to some example embodiments of the present disclosure;

FIG. 18 illustrates a top view of the resonant arrangement of FIG. 17 according to some example embodiments of the present disclosure;

FIG. 19 show a filter response of the resonant arrangement in FIG. 18 according to some example embodiments of the present disclosure;

FIG. 20 illustrates a top view of a plurality of resonant arrangements according to some example embodiments of the present disclosure;

FIG. 21 illustrates a top view of a plurality of resonant arrangements without upper housing according to some example embodiments of the present disclosure; and

FIG. 22 shows an apparatus comprising the cavity filter according to some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “some example embodiments,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with some example embodiments, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/of” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

The term “housing” used herein can refer to a structure that houses an object and at least partially covers and protects the object. The term “cavity” used herein can refer to a hollow space which can be filled with air or dielectric materials. The term “planar” used herein can describe something that is substantially in a tow-dimensional flate plane. The term “resonant component” or “resonator” used herein can refer to a structure that supports electromagnetic resonance. The term “lead” used herein can refer to a physical interconnect. The term “head” used herein can refer to a terminating portion of a structure that is larger than an interconnecting neck portion.

A filter, for example, radio frequency (RF) filter is a key component in 5G/Massive MIMO systems, which can reject the harmonics and spurious and make signals more clear. Conventionally, the filter may occupy more than 20% of the whole unit size and weight. Therefore, how to reduce the filter size and weight is quite important in 5G/Massive MIMO systems.

According to embodiments of the present disclosure, there is providing an improved cavity filter. The cavity filter comprises a housing which defines a cavity and a resonator arrangement which comprises a plurality of resonant components. The plurality of resonant components are arranged in a common plane inside the cavity. The plurality of resonant components comprises at least three resonant components, for example, a first resonant component, a second resonant component and a third resonant component. The first, second and third resonant components are arranged in an interdigital structure and spaced apart from each other. At least two of the first, second and third resonant components are arranged to be connected through a connection strip. In this way, it reduces the size and weight of the filter. It also achieves cost reduction. Moreover, it is also more flexible do design.

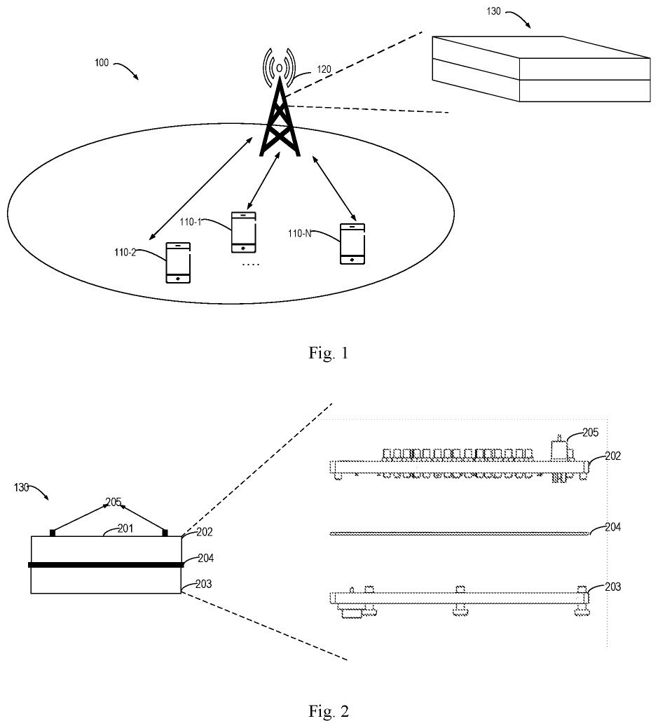

Principle and embodiments of the present disclosure will be described in detail below with reference to the accompanying drawings. Reference is first made to FIG. 1, which illustrates an example communication system 100 in which example embodiments of the present disclosure may be implemented.

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number.

The communication system 100 further comprises a network device 120. In the communication system 100, the network device 120 and the terminal devices 110 can communicate data and control information to each other. The numbers of devices shown in FIG. 1 are given for the purpose of illustration without suggesting any limitations. The cavity filer 130 can be implemented at the network device 120.

It is to be understood that the number of network devices and terminal devices is only for the purpose of illustration without suggesting any limitations. The system 100 may include any suitable number of network devices and terminal devices adapted for implementing embodiments of the present disclosure. Although not shown, it would be appreciated that one or more terminal devices may be located in the cell 102.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Reference is now made to FIG. 2, which shows a block diagram of a structure of the cavity filter 130 according to some example embodiments of the present disclosure. The cavity filter 130 comprises a housing 201 and a resonant arrangement 204. In some embodiments, the housing 201 can comprise at least a first housing component defining a first part of the cavity and a second housing component defining a second part of the cavity. The first part of the cavity and the second part of the cavity are separated by the common plane and the resonator arrangement is secured to the first housing and the second housing to suspend planar heads of the plurality of resonant components in the common plane between the first part of the cavity and the second part of the cavity For example, the housing 201 can comprise an upper housing 202 which is above the resonant arrangement 204 and a bottom housing 203 which is beneath the resonant arrangement 204. There can be input/output (I/O) port 205 on the cavity filter 130. In some embodiments, the cavity filter 130 may also comprise tunning screw(s) which is used to tune the resonant frequency. The housing 201 can be made of any proper materials. The housing can be made of metal such as Aluminum. In some embodiments, the housing 201 can be made of plastic materials and the surface of the housing can be plated by silver or copper to improve the conductivity of the surface so as to reduce the RF signal loss. The resonant arrangement 204 can be implemented on a metal sheet. It should be noted that the resonant arrangement can be implemented on any suitable materials. The resonant arrangement 204 can be assembled between the upper housing 202 and the bottom housing 203 by screw fixing or soldering. In some embodiments, the housing 201 can comprise a plurality of cavities. Each of the cavities can comprise one resonant arrangement 204.

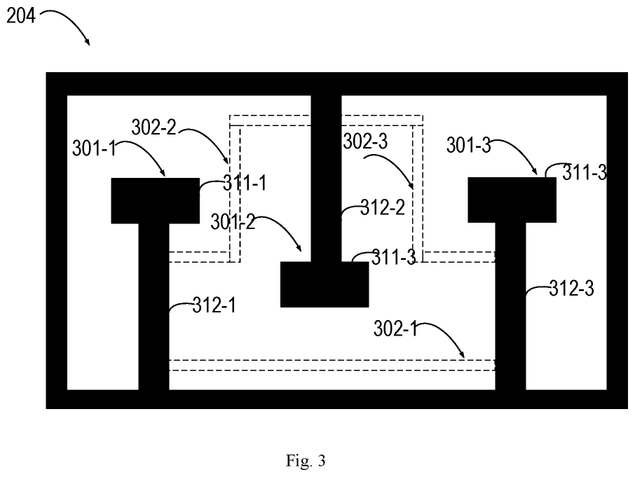

FIG. 3 illustrates a block diagram of the resonant arrangement 204 of the filter according to some example embodiments of the present disclosure. The resonant arrangement 204 comprises a resonant component 301-1, a resonant component 301-2 and a resonant component 301-3. It should be noted that the resonant arrangement 204 can comprise any suitable number of resonant components (referred to as “resonant component 301”). The resonant components 301-1, 301-2 and 301-3 are arranged in an interdigital structure and spaced apart from each other. The term “interdigital structure” used herein refers to a structure which comprises two interlocking comb-shaped arrays of components. For example, as shown in FIG. 3, the resonant component 301-2 is in an inverse direction with the resonant component 301-2 and the resonant component 310-3 is in an inverse direction with the resonant component 301-2. At least two of the resonant components can be connected through a connection strip. As shown in FIG. 3, the resonant components 301-1 and 301-3 can be connected through a connection strip 302-1, the resonant components 301-1 and 301-2 can be connected through a connection strip 302-2 and the resonant components 301-2 and 301-3 can be connected through a connection strip 302-3.

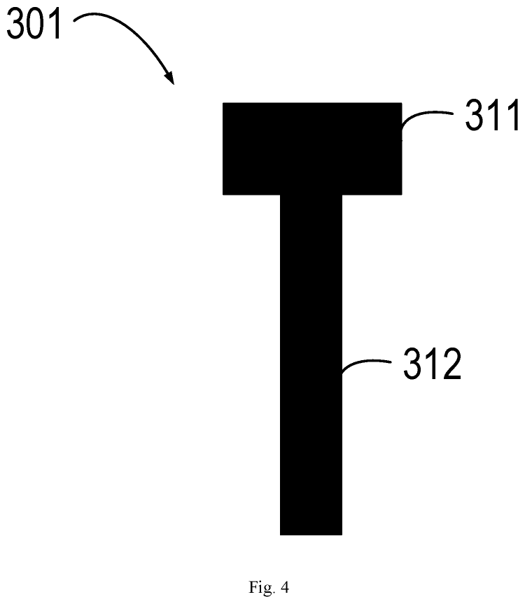

FIG. 4 illustrates a schematic diagram of the resonant component 301 according to some example embodiments of the present disclosure. The resonant component 301 can comprise a planar head 311 and an elongate planar lead 312 which terminates at the planar head 311. For example, as shown in FIG. 3, the resonant component 301-1 can comprise a planar head 311-1 and an elongate planar lead 312-1 which terminates at the planar head 311-1, the resonant component 301-2 can comprise a planar head 311-2 and an elongate planar lead 312-2 which terminates at the planar head 311-2, and the resonant component 301-3 can comprise a planar head 311-3 and an elongate planar lead 312-3 which terminates at the planar head 311-3. It should be noted that the structure in FIG. 4 is only an example not limitation. The resonant component 301 can be any proper structure. For example, the resonant component 301 can be a rectangular strip. The sizes of the elongate planar lead and the planar head can be associated with the resonant frequency of the cavity filer. For example, the electrical length of the resonant component 301 can be substantially one quarter of the resonant wavelength.

As is known to those skilled in the art, the resonant frequency of a cavity filter is determined by the complex impedance of the cavity filter. The complex impedance of the cavity filter can be configured by changing the inductance and/or capacitance associated with each resonant component 301. This can be achieved by controlling the dimensions of the elongate planar leads and of the planar heads and by controlling the pitch between the resonant component. In this way, it is possible to control the gap between the adjacent planar leads and the gap between the planar heads and the housing. The control of these dimensions can be used to control the inductance capacitance and consequently the resonant frequency and bandwidth of the cavity filter 130.

In the examples illustrated in the above-mentioned figures, the planar leads and the planar heads have been identical. However this is not necessarily the case. It is, for example, possible to separately vary the dimensions of one planar resonator relative to another planar resonator, for example an adjacent planar resonator. In the above examples, the elongate planar leads have been illustrated as parallel. While this may be the case in some examples, it is not necessarily the case in all examples.

Referring back to FIG. 3, the connection points of the connection strip can be on the resonator leg area. The closer of the connection points to the resonator head, the stronger of the coupling between each resonant component. In some embodiments, the resonant component 301-1 is a cantilever that is anchored by an elongate planar lead 312-1 and that suspends a planar head 311-1 within the cavity. The planar head 311-1 is supported by only the elongate planar lead 312-1 at a first fixed position within the cavity. Similarly, the resonant component 301-2 is a cantilever that is anchored by an elongate planar lead 312-2 and that suspends a planar head 311-2 within the cavity. The planar head 311-2 is supported by only the elongate planar lead 312-2 at a second fixed position within the cavity. The resonant component 301-3 is a cantilever that is anchored by an elongate planar lead 312-3 and that suspends a planar head 311-3 within the cavity. The planar head 311-3 is supported by only the elongate planar lead 312-3 at a third fixed position within the cavity.

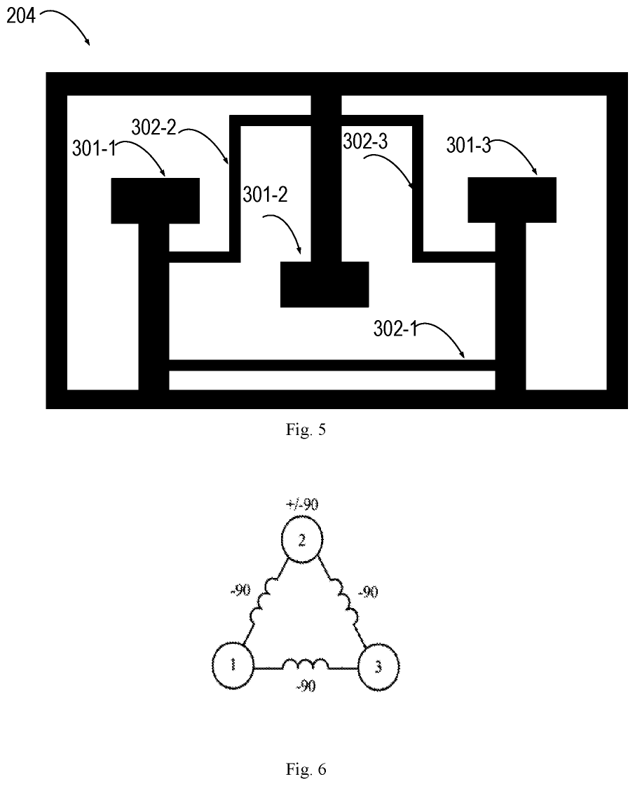

FIGS. 5-16 show schematic diagrams of example resonant arrangement and the corresponding performances according to embodiments of the present disclosure. It should be noted that structures of the resonant arrangements shown in FIGS. 5-16 are only examples not limitations.

As shown in FIG. 5, the resonant arrangement 204 comprises a resonant component 301-1, a resonant component 301-2 and a resonant component 301-3. The resonant components 301-1, 301-2 and 301-3 are arranged in an interdigital structure and spaced apart from each other. The resonant components 301-1 and 301-3 are connected through a connection strip 302-1, the resonant components 301-1 and 301-2 are connected through a connection strip 302-2 and the resonant components 301-2 and 301-3 are connected through a connection strip 302-3.

FIG. 6 shows a topology of the resonant arrangement shown in FIG. 5. In this topology, the resonant components can realize a cascaded triplet topology. Due to the connection strip, the coupling between each resonant components are inductive couplings signed in passive(+), and the phase shift −90 degree.

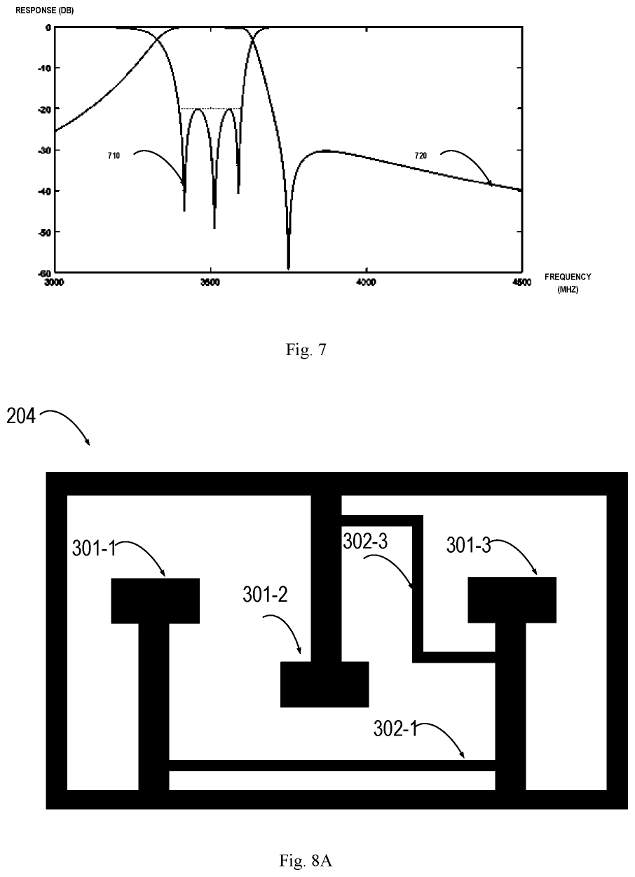

FIG. 7 shows a filer response of the resonant arrangement in FIG. 5. For example, FIG. 7 shows a plot of a return loss S11 (represented as 710) and a plot of an insertion loss S21 (represented as 720). Only as an example, the centre frequency can be around at 3500 MHz and the pass-band width can be around 250 MHz. The transmission zero is on the higher band as shown in FIG. 7, for example, at about 3750 MHz. The coupling strength can be determined based on the connection points of the connection strip. By adjusting to the connection positions, the coupling strength can be adjusted according to the filter design.

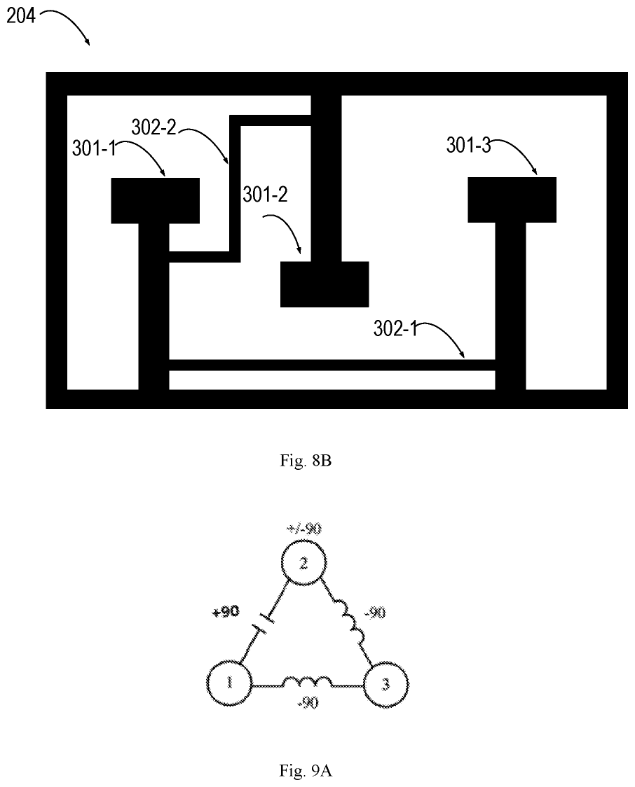

In some embodiments, one connection between resonant components can be removed and the transmission zeros can be changed to the left band. FIGS. 8A and 8B illustrate block diagrams of resonant arrangements of the filter where there are two connection strips in one resonant arrangement.

As shown in FIG. 8A, the resonant arrangement 204 comprises a resonant component 301-1, a resonant component 301-2 and a resonant component 301-3. The resonant components 301-1, 301-2 and 301-3 are arranged in an interdigital structure and spaced apart from each other. The resonant components 301-1 and 301-3 are connected through a connection strip 302-1, the resonant components 301-1 and 301-2 are disconnected, and the resonant components 301-2 and 301-3 are connected through a connection strip 302-3.

As shown in FIG. 8B, the resonant arrangement 204 comprises a resonant component 301-1, a resonant component 301-2 and a resonant component 301-3. The resonant components 301-1, 301-2 and 301-3 are arranged in an interdigital structure and spaced apart from each other. The resonant components 301-1 and 301-3 are connected through a connection strip 302-1, the resonant components 301-1 and 301-2 are connected through a connection strip 302-2 and the resonant components 301-2 and 301-3 are disconnected.

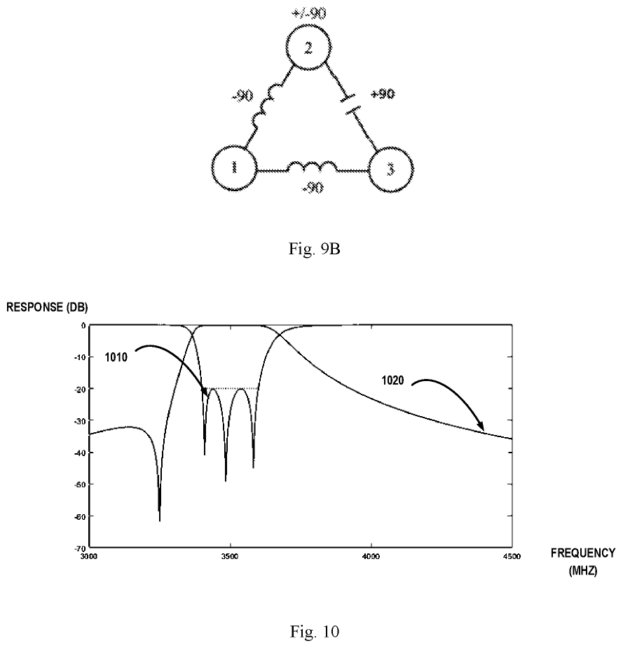

FIG. 9A shows a topology of the resonant arrangement shown in FIG. 8A. Due to the disconnection between the resonant components 301-1 and 301-2, the coupling between the resonant components 301-1 and 301-2 are capacitance couplings signed in negative (−). FIG. 9B shows a topology of the resonant arrangement shown in FIG. 8B. Due to the disconnection between the resonant components 301-2 and 301-3, the coupling between the resonant components 301-2 and 301-3 are capacitance couplings signed in negative (−).

FIG. 10 shows a filer response of the resonant arrangement in FIGS. 8A and 8B. For example, FIG. 10 shows a plot of a return loss S11 (represented as 1010) and a plot of an insertion loss S21 (represented as 1020). Only as an example, the center frequency can be around at 3500 MHz and the pass-band width can be around 250 MHz. The transmission zero is on the lower band as shown in FIG. 10, for example, at about 3250 MHz. The coupling strength can be determined based on the connection points of the connection strip.

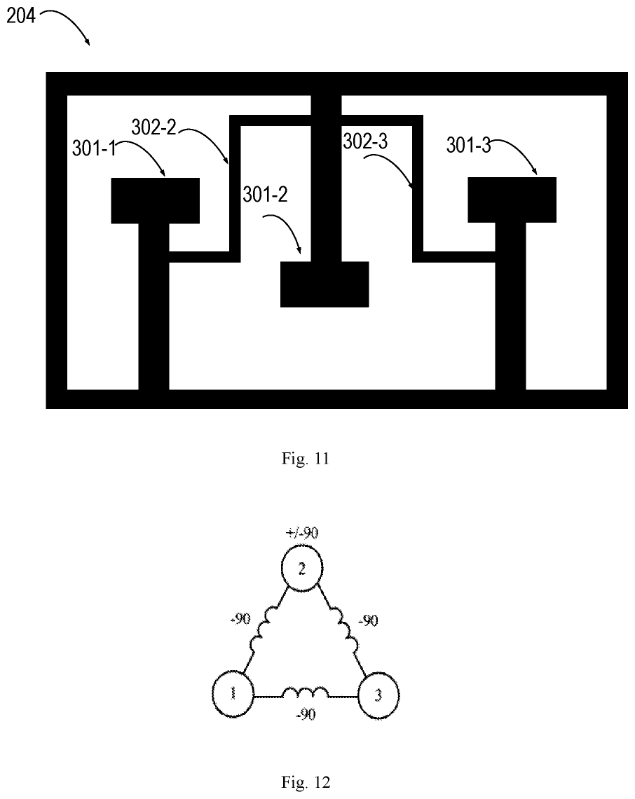

Alternatively, as shown in FIG. 11, the resonant arrangement 204 comprises a resonant component 301-1, a resonant component 301-2 and a resonant component 301-3. The resonant components 301-1, 301-2 and 301-3 are arranged in an interdigital structure and spaced apart from each other. The resonant components 301-1 and 301-3 are disconnected, the resonant components 301-1 and 301-2 are connected through a connection strip 302-2 and the resonant components 301-2 and 301-3 are connected through a connection strip 302-3.

FIG. 12 shows a topology of the resonant arrangement shown in FIG. 11. In this topology, the resonant components can realize a cascaded triplet topology. Due to the connection strip, the coupling between each resonant components are inductive couplings signed in passive (+), and the phase shift −90 degree.

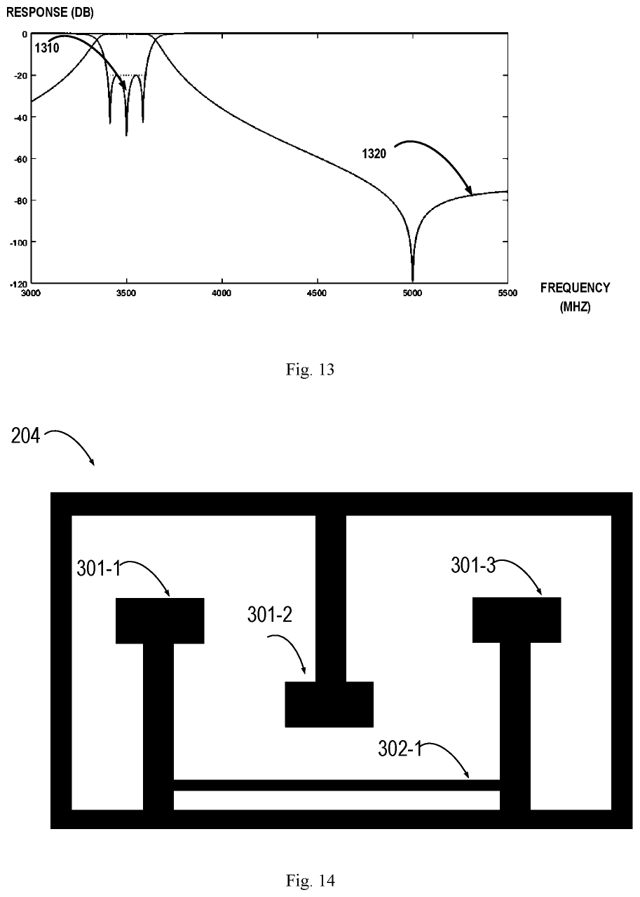

FIG. 13 shows a filer response of the resonant arrangement in FIG. 11. For example, FIG. 13 shows a plot of a return loss S11 (represented as 1310) and a plot of an insertion loss S21 (represented as 1320). Only as an example, the centre frequency can be around at 3500 MHz and the pass-band width can be around 250 MHz. The transmission zero is on the higher band as shown in FIG. 12, for example, at about 5000 MHz.

In some embodiments, two connection strips between two adjacent resonant components can be removed. For example, as shown in FIG. 14, the resonant arrangement 204 comprises a resonant component 301-1, a resonant component 301-2 and a resonant component 301-3. The resonant components 301-1, 301-2 and 301-3 are arranged in an interdigital structure and spaced apart from each other. The resonant components 301-1 and 301-3 are connected through a connection strip 302-1, the resonant components 301-1 and 301-2 are disconnected and the resonant components 301-2 and 301-3 are disconnected.

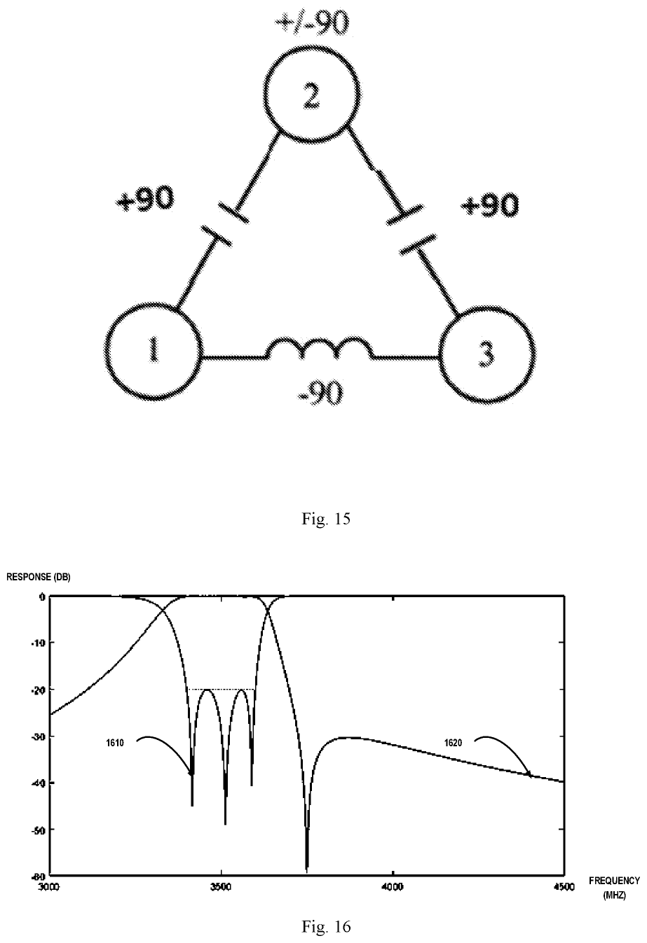

FIG. 15 shows a topology of the resonant arrangement shown in FIG. 14. Due to the disconnection between the resonant components 301-1 and 301-2 and the disconnection between the resonant components 301-2 and 301-3, the coupling between the resonant components 301-1 and 301-2 are capacitance couplings signed in negative (−) and the coupling between the resonant components 301-2 and 301-3 are capacitance couplings signed in negative (−).

FIG. 16 shows a filer response of the resonant arrangement in FIG. 14. For example, FIG. 16 shows a plot of a return loss S11 (represented as 1610) and a plot of an insertion loss S21 (represented as 1620). Only as an example, the centre frequency can be around at 3500 MHz and the pass-band width can be around 250 MHz. The transmission zero is on the higher band as shown in FIG. 7, for example, at about 3750 MHz.

In some embodiments, the cavity filer 130 can comprise another housing which is similar to the housing 210 and an additional resonator arrangement which is similar to the resonator arrangement 204.

According to embodiments of the present disclosure, benefits of the filter can comprise (1) size reduction, (2) weight reduction, (3) cost reduction. Moreover, the transmission zeros of the innovation is quite easy in design and all filter parts can be designed in one sheet metal. Further, it is easy for manufacture and tuning and filter module assembly is quite easy and time saving. The filter tuning is also easy and time saving.

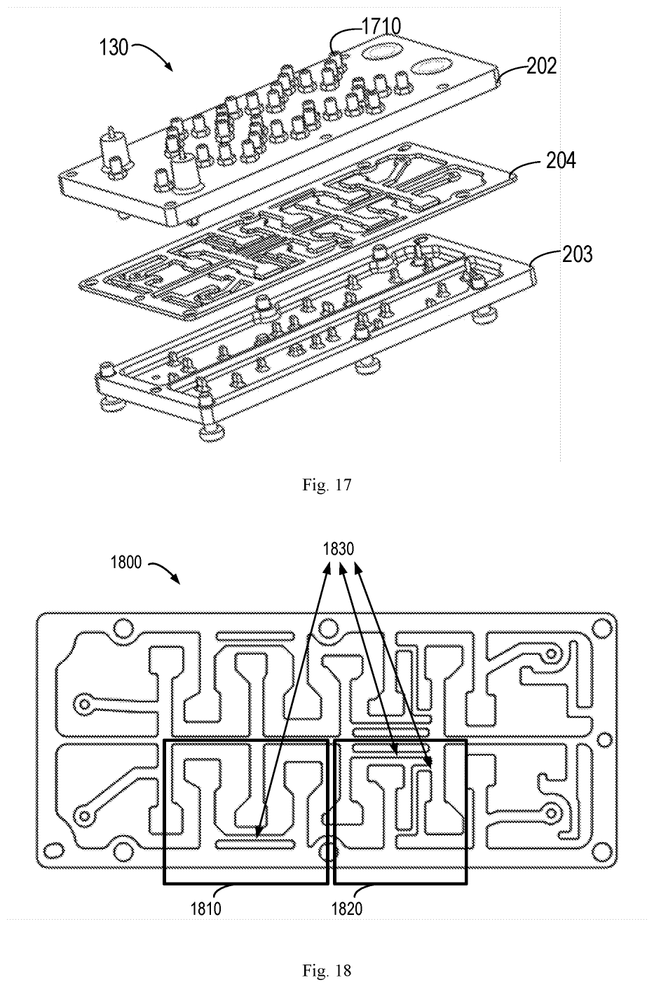

FIG. 17 illustrates a stereoscopic view of a cavity filter according to some example embodiments of the present disclosure. In some embodiments, the sheet metal filter can be implemented in RF 6.15G massive MIMO Radio produce. A single pipe filter 130 is shown in FIG. 17. The filter 130 can comprise an upper housing 202, a resonator arrangement 204 and a bottom housing 202. The filter 130 can be tuned by tuning screws 1710.

FIG. 18 illustrates a top view of the resonant arrangement of FIG. 17 according to some example embodiments of the present disclosure. As shown in FIG. 18, the resonant arrangement 1800 can comprise more than one resonant arrangement 204 described above. For example, the resonant arrangement 1800 can comprise the resonant arrangement 1810 which is similar to the structure shown in FIG. 14. The resonant arrangement 1800 can also comprise the resonant arrangement 1820 which is similar to the structure shown in FIGS. 8A and 8B. The resonant arrangement 1800 can comprise a plurality of connection strips shown as 1830.

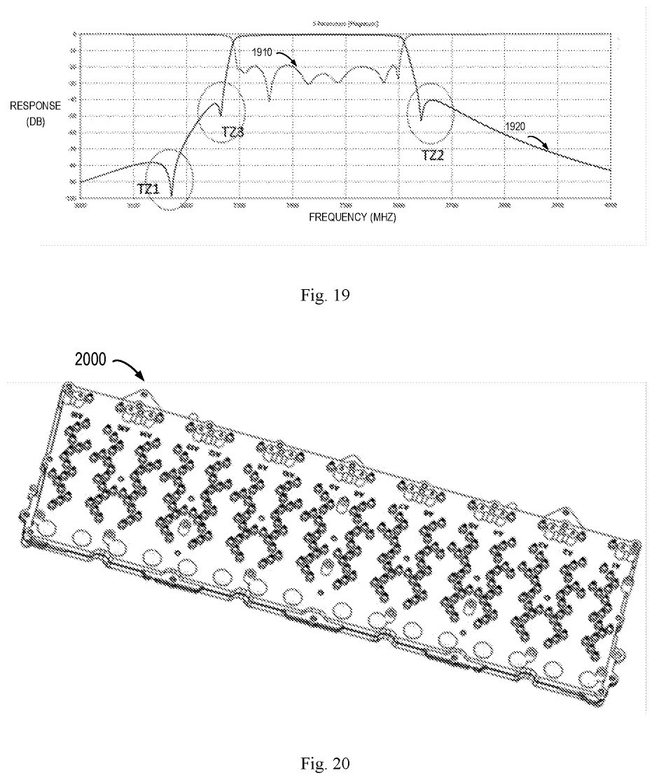

FIG. 19 shows a filter response of the resonant arrangement in FIG. 18 according to some example embodiments of the present disclosure. For example, FIG. 19 shows a plot of a return loss S11 (represented as 1910) and a plot of an insertion loss S21 (represented as 1920). The resonant arrangement 1820 can realize one transmission zero at lower band (TZ1) and the resonant arrangement 1810 can realize one transmission zero at higher band (TZ2). A notch resonator is for TZ3 at the lower band.

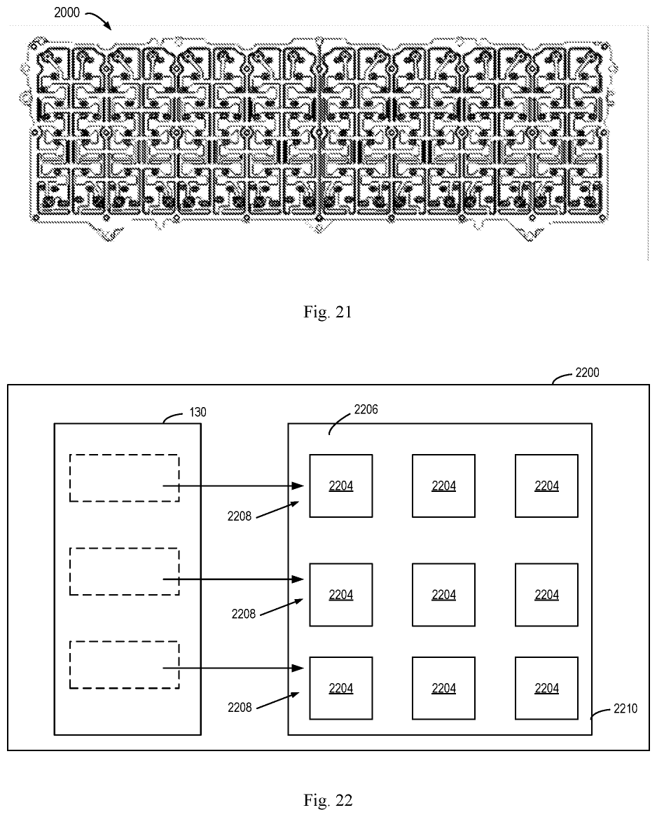

FIG. 20 illustrates a top view of a plurality of resonant arrangements according to some example embodiments of the present disclosure. FIG. 21 illustrates a top view of a plurality of resonant arrangements shown in FIG. 20 without upper housing according to some example embodiments of the present disclosure. Only as an example, as the sheet metal strip is more stable in by the connection strips between the resonators, the filter can be made into filter array 1*16 pipes in one filter module design, which is for filter intergration and further cost reduction, shown in FIG. 20. In other words, the filter module 2000 comprises 16 resonant arrangements. It should be noted that the filter module 2000 is only an example not limitation.

FIG. 22 illustrates an example of an apparatus 2200 comprising one or more cavity filters 130. The apparatus 2200 may be a node in a wireless network or system, such as a wireless mobile communication network or system, satellite communication network or system, television broadcast network or system, a modulated radio broadcast network or system, or a RADAR network or system. This example illustrates an apparatus 2200 comprising one or more cavity filters 130 and an antenna arrangement 2210.

This example illustrates a base station 120 of a mobile cellular communications network comprising one or more cavity filters 130 and an antenna arrangement 2210. In this example, but not necessarily all examples the antenna arrangement comprises multiple radiator elements 2210 arranged in a two-dimensional array 2206 comprising multiple, parallel, one-dimensional sub arrays 2208. In this example, but not necessarily all examples each one-dimensional sub-array 2208 is associated with a cavity (and associated planar resonator arrangement) of a cavity filter 130. This arrangement may be used for massive multiple input multiple output.

Where a structural feature has been described, it may be replaced by means for performing one or more of the functions of the structural feature whether that function or those functions are explicitly or implicitly described.

The operational frequency B may be within or cover (but are not limited to) Long Term Evolution (LTE) (US) (734 to 746 MHz and 869 to 894 MHz), Long Term Evolution (LTE) (rest of the world) (791 to 821 MHz and 925 to 960 MHz), amplitude modulation (AM) radio (0.535-1.705 MHz); frequency modulation (FM) radio (76-108 MHz); Bluetooth (2400-2483.5 MHz); wireless local area network (WLAN) (2400-2483.5 MHz); hiper local area network (HiperLAN) (5150-5850 MHz); global positioning system (GPS) (1570.42-1580.42 MHz); US—Global system for mobile communications (US-GSM) 850 (824-894 MHz) and 1900 (1850-1990 MHz); European global system for mobile communications (EGSM) 900 (880-960 MHz) and 1800 (1710-1880 MHz); European wideband code division multiple access (EUWCDMA) 900 (880-960 MHz); personal communications network (PCN/DCS) 1800 (1710-1880 MHz); US wideband code division multiple access (US-WCDMA) 1700 (transmit: 1710 to 1755 MHz, receive: 2110 to 2155 MHz) and 1900 (1850-1990 MHz); wideband code division multiple access (WCDMA) 2100 (transmit: 1920-1980 MHz, receive: 2110-2180 MHz); personal communications service (PCS) 1900(1850-1990 MHz); time division synchronous code division multiple access (TDSCDMA) (1900 MHz to 1920 MHz, 2010 MHz to 2025 MHz), ultra wideband (UWB) Lower (3100-4900 MHz); UWB Upper (6000-10600 MHz); digital video broadcasting-handheld (DVB-H) (470-702 MHz); DVB-H US (1670-1675 MHz); digital radio mondiale (DRM) (0.15-30 MHz); worldwide interoperability for microwave access (WiMax) (2300-2400 MHz, 2305-2360 MHz, 2496-2690 MHz, 3300-3400 MHz, 3400-3800 MHz, 5250-5875 MHz); digital audio broadcasting (DAB) (174.928-239.2 MHz, 1452.96-1490.62 MHz); radio frequency identification low frequency (RFID LF) (0.125-0.134 MHz); radio frequency identification high frequency (RFID HF) (13.56-13.56 MHz); radio frequency identification ultra high frequency (RFID UHF) (433 MHz, 865-956 MHz, 2450 MHz) and frequency bands for 5G.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A cavity filter, comprising:
a housing, defining a cavity;
a resonator arrangement comprising a plurality of resonant components that are arranged in a common plane inside the cavity, wherein the plurality of resonant components at least comprises: a first resonant component, a second resonant component, and a third resonant component, the first, second and third resonant components arranged in an interdigital structure and to be spaced apart from each other, and at least two of the first, second and third resonators arranged to be connected through a connection strip.

2. The cavity filter of claim 1, wherein the first resonant component and the second resonant component are connected through a first connection strip, the first resonant component and the third resonant component are connected through a second connection strip, and the second resonant component and the third resonant component are connected through a third connection strip.

3. The cavity filter of claim 1, wherein the first resonant component and the second resonant component are connected through a first connection strip, the first resonant component and the third resonant component are connected through a second connection strip, and the second resonant component and the third resonant component are disconnected.

4. The cavity filter of claim 1, wherein the first resonant component and the second resonant component are connected through a first connection strip, the first resonant component and the third resonant component are disconnected, and the second resonant component and the third resonant component are connected through a third connection strip.

5. The cavity filter of claim 1, wherein the first resonant component and the second resonant component are disconnected, the first resonant component and the third resonant component are not connected, and the second resonant component and the third resonant component are connected through a third connection strip.

6. The cavity filter of claim 1, wherein the first resonant component and the second resonant component are connected through a first connection strip, the first resonant component and the third resonant component are disconnected, and the second resonant component and the third resonant component are disconnected.

7. The cavity filter of claim 1, wherein the first resonant component comprises a first elongate planar lead terminating at a first planar head,
the second resonant component comprises a second elongate planar lead terminating at a second planar head, and
the third resonant component comprises a third elongate planar lead terminating at a third planar head, and
wherein the first elongate planar lead, the first planar head, the second elongate planar lead, the second planar head, the third elongate planar lead and the third planar head extend within the common plane.

8. The cavity filter of claim 7, wherein the first resonant component is a cantilever that is anchored by the first elongate planar lead and that suspends the first planar head within the cavity, wherein the first planar head is supported by only the first elongate planar lead at a first fixed position within the cavity,
wherein the second resonant component is a cantilever that is anchored by the second elongate planar lead and that suspends the second planar head within the cavity, wherein the second planar head is supported by only the second elongate planar lead at a second fixed position within the cavity, and
wherein the third resonant component is a cantilever that is anchored by the third elongate planar lead and that suspends the third planar head within the cavity, wherein the third planar head is supported by only the third elongate planar lead at a third fixed position within the cavity.

9. The cavity filter of claim 1, wherein the housing comprises at least a first housing component defining a first part of the cavity and a second housing component defining a second part of the cavity, wherein the first part of the cavity and the second part of the cavity are separated by the common plane; and wherein the resonator arrangement is secured to the first housing and the second housing to suspend planar heads of the plurality of resonant components in the common plane between the first part of the cavity and the second part of the cavity.

10. The cavity filter of claim 1, wherein the common plane bi-sects the cavity.

11. The cavity filter of claim 1, wherein the housing comprises at least a first housing component defining a first part of the cavity and a second housing component defining a second part of the cavity, wherein the resonator arrangement is a component that is separable, as an intact component, from the first housing component and the second housing component and that is placed between the first housing component and second housing component and wherein the resonator arrangement comprises an outer frame, defining a plane, and the plurality of resonant components extending from the frame and lying in the plane.

12. The cavity filter of claim 1, wherein the resonator arrangement is formed from a sheet of metal.

13. The cavity filter of claim 1, wherein the housing, comprises a plurality of cavities, wherein each of the cavities of the plurality of cavities comprises one resonator arrangement.

14. The cavity filter of claim 1, further comprising:
an additional housing, defining an additional cavity, the additional housing comprising at least a first additional housing component defining a first part of the additional cavity and a second additional housing component defining a second part of the additional cavity; and
an additional resonator arrangement comprising multiple additional resonant components that are arranged in an additional common plane between the first additional part of the additional cavity and the second additional part of the additional cavity, wherein the housing and the additional housing are stacked so that the common plane and the additional common plane are parallel but separated.

15. An apparatus comprising:
one or more cavity filters as claimed in any preceding claim;
an antenna arrangement comprising multiple radiator elements arranged in a two-dimensional array comprising multiple, parallel, one-dimensional sub arrays, wherein each one-dimensional sub-array is associated with a cavity of a cavity filter.

16. An apparatus as claimed in claim 15 configured as a node for a wireless network or system, a wireless mobile communication network or system, a satellite communication network or system, a television broadcast network or system, a modulated radio broadcast network or system, or a RADAR network or system.

17. An apparatus comprising:
a housing, defining a cavity;
a resonator arrangement comprising a plurality of resonant components that are arranged in a common plane inside the cavity, wherein the plurality of resonant components at least comprises: a first resonant component, a second resonant component, and a third resonant component, the first, second and third resonant components arranged in an interdigital structure and to be spaced apart from each other, and at least two of the first, second and third resonators arranged to be connected through a connection strip; and
an antenna arrangement comprising multiple radiator elements arranged in a two-dimensional array comprising multiple, parallel, one-dimensional sub arrays, wherein each one-dimensional sub-array is associated with a cavity of a cavity filter.
